(19) United States
(12) Patent Application Publication
(10) Pub. No.: US 2026/0304278 A1
(43) Pub. Date: Oct. 1, 2026

(54) OPTIMIZED HIGH ACCURACY ROAMING WITH FINE TIME MEASUREMENT AND DYNAMIC BANDWIDTH MECHANISMS

(71) Applicant: Cisco Technology, Inc., San Jose, CA (US)

(72) Inventors: Malcolm Muir Smith, Richardson, TX (US); Binita Gupta, San Diego, CA (US); Alan W. Dumdei, Greenville, TX (US)

(73) Assignee: Cisco Technology, Inc., San Jose, CA (US)

(21) Appl. No.: 19/468,746

(22) Filed: Feb. 3, 2026

Related U.S. Application Data
(60) Provisional application No. 63/753,036, filed on Feb. 3, 2025.

(51) Int. Cl. H04W 36/32; H04B 1/7163; H04W 36/00; H04W 36/18; H04W 64/00

(52) U.S. Cl. CPC H04W 36/322; H04B 1/7163; H04W 36/0016; H04W 36/00835; H04W 36/18; H04W 64/00

(57) ABSTRACT

High accuracy roaming with location determination and dynamic bandwidth mechanisms may be provided. High accuracy roaming includes operating, by an access point (AP), at a baseline operating bandwidth. The AP expands from the baseline operating bandwidth to an expanded operating bandwidth for a station (STA) associated with the AP. The AP and the STA perform a location determination procedure at the expanded operating bandwidth to determine location information for the STA. The AP contracts from the expanded operating bandwidth to the baseline operating bandwidth and utilizes the location information to determine one or more candidate target APs for roaming of the STA from the AP to at least one of the one or more candidate target APs. The STA and AP can perform roaming preparation and roaming execution based on the candidate target APs.

### RELATED APPLICATION

Under provisions of 35 U.S.C. § 119(e), Applicant claims the benefit of and priority to U.S. Provisional Application No. 63/753,036, filed Feb. 2, 2025, the disclosure of which is incorporated herein by reference in its entirety.

### TECHNICAL FIELD

The present disclosure relates generally to providing high accuracy roaming with location determination and dynamic bandwidth mechanisms.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for roaming with location determination and dynamic bandwidth mechanisms in accordance with aspects of the present disclosure.

FIG. 2 illustrates a seamless roaming process in accordance with aspects of the present disclosure.

FIG. 3 is message exchange diagram illustrating a first procedure for coordinating dynamic bandwidth mechanisms with FTM-based location determination to optimize seamless roaming in accordance with aspects of the present disclosure.

FIG. 4 is message exchange diagram illustrating a second procedure for coordinating dynamic bandwidth mechanisms with FTM-based location determination to optimize seamless roaming in accordance with aspects of the present disclosure.

FIG. 5 is message exchange diagram illustrating a third procedure for coordinating dynamic bandwidth mechanisms with FTM-based location determination to optimize seamless roaming in accordance with aspects of the present disclosure.

FIG. 6 is a flow diagram illustrating a method 600 for optimizing seamless roaming in a wireless network by coordinating dynamic bandwidth mechanisms with location determination procedures.

FIG. 7 is a block diagram of a computing device in accordance with aspects of the present disclosure.

FIG. 8 is a block diagram of a communications device in accordance with aspects of the present disclosure.

### DETAILED DESCRIPTION

### Overview

High accuracy roaming with location determination and dynamic bandwidth mechanisms may be provided. High accuracy roaming includes operating, by an access point (AP), at a baseline operating bandwidth. The AP expands from the baseline operating bandwidth to an expanded operating bandwidth for a station (STA) associated with the AP. The AP and the STA perform a location determination procedure at the expanded operating bandwidth to determine location information for the STA. The AP contracts from the expanded operating bandwidth to the baseline operating bandwidth and utilizes the location information to determine one or more candidate target APs for roaming of the STA from the AP to at least one of the one or more candidate target APs. The STA and AP can perform roaming preparation and roaming execution based on the candidate target APs.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi networks occurs when a client device (Station or STA) transitions its connection from one Access Point (AP) to another AP, typically because the STA has moved outside the range of its current AP or has identified another AP that can provide a better connection. Current roaming decisions are primarily made by client devices based on Received Signal Strength Indicator (RSSI) measurements, supplemented by network recommendations from the serving AP regarding suitable neighbor APs. While various approaches have been proposed to improve candidate neighbor suggestions using Machine Learning (ML) and Artificial Intelligence (AI), particularly those based on STA trajectory predictions derived from Wi-Fi Fine Time Measurement (FTM) location tracking, these approaches face fundamental accuracy limitations in typical enterprise deployments.

Seamless roaming techniques can be utilized to reduce roaming latency and improve user experience during AP transitions. Non-Multi-Link Device (MLD) seamless roaming techniques include those described in IEEE 802.11k, which reduces the time required to roam by allowing a client to more quickly determine which AP it should roam to next and how, with the current AP providing information regarding neighboring APs and their channels so that when the client is ready to roam, it has a better idea of where it will be roaming to. Another non-MLD technique is described in IEEE 802.11r, which uses Fast Basic Service Set (BSS) Transition (FT) to allow encryption keys to be stored on all of the APs in a network, enabling a client to avoid performing the complete authentication process to a backend server every time it roams to a new AP within the network, thus avoiding significant latency that would have previously delayed network connectivity.

MLD-based seamless roaming as defined in the IEEE 802.11bn amendment introduces Seamless Mobility Domains (SMDs), which are logical, secure groupings of multiple AP MLDs or controllers that enable client devices to roam between them without disconnecting, re-authenticating, or experiencing packet loss. MLD-based seamless roaming enables a “make-before-break” approach where a device establishes a connection to a new AP before releasing the old one by utilizing multiple links. The IEEE 802.11bn seamless roaming procedures include a roaming preparation phase during which the STA and serving AP exchange signaling to prepare one or more target APs for the upcoming roaming transition, followed by a roaming execution phase during which the actual transition to the target AP occurs. The roaming preparation phase may include negotiation of target APs, establishment of security associations with target APs, and preparation of link configurations, enabling the subsequent roaming execution to occur with minimal latency and data loss.

FTM is a ranging technique that enables location determination based on time of flight measurements of signals between devices. However, the accuracy of FTM-based location determination is inherently limited by the operating bandwidth of the wireless channel. Enterprise Wi-Fi networks typically operate with relatively narrow channel bandwidths, such as 20 or 40 MHz, even in the 6 GHz band where spectrum availability varies by regulatory domain (for example, European deployments may use 40 MHz while United States deployments may use up to 80 MHz). Achieving high-accuracy location determination including precise trajectory tracking with FTM generally requires significantly wider bandwidths, such as 160 MHz or 320 MHz. This mismatch between typical enterprise operating bandwidths and the bandwidth requirements for accurate FTM presents a substantial obstacle to implementing effective trajectory-based roaming predictions. Other ranging techniques for accurate ranging include an ultra-wideband location determination for determining position and trajectory.

Additionally, dynamic bandwidth mechanisms, such as Dynamic Bandwidth Expansion (DBE) defined by the IEEE 802.11bn amendment, Dynamic Bandwidth Selection (DBS), Dynamic Sub-Band Operation (DSO), and Non-Primary Channel Access (NPCA) allow network devices to temporarily expand an operating bandwidth from a narrow baseline (such as 20 or 40 MHz) to a wider bandwidth (such as 160 or 320 MHz) for specific purposes. While seamless roaming, FTM-based location determination, and dynamic bandwidth mechanisms all provide benefits when implemented independently, current approaches do not coordinate these mechanisms to optimize the overall roaming process in enterprise deployments where baseline operating bandwidths are constrained.

To address these limitations, techniques are described herein for coordinating dynamic bandwidth mechanisms with FTM-based location determination and seamless roaming procedures to optimize roaming accuracy while minimizing overall bandwidth usage and interference impacts. The dynamic bandwidth mechanisms enable a network to temporarily expand its operating bandwidth from a narrow baseline bandwidth, such as 20 MHz or 40 MHz, to a wider bandwidth, such as 160 MHz or 320 MHz, for specific purposes without requiring permanent operation at the wider bandwidth. However, expanding the operating bandwidth from a narrow baseline to a wider bandwidth (for example, from 40 MHz to 320 MHz) temporarily occupies spectrum that may overlap with channels used by neighboring BSSs, potentially causing co-channel interference or adjacent channel interference that degrades network performance for other users. Prolonged bandwidth expansion can also reduce overall spectrum efficiency in dense deployment environments where multiple BSSs must share limited available channels. Additionally, continuous operation at expanded bandwidth increases network overhead and may impact legacy stations operating in the same or nearby BSSs, even when the dynamic bandwidth mechanisms are designed to minimize such impacts. Therefore, the period during which the bandwidth expansion occurs should be minimized. By coordinating this temporary bandwidth expansion with FTM ranging procedures at strategically selected times during the roaming process, the techniques enable high-accuracy location determination, including trajectory estimation, even in enterprise deployments that normally operate at narrow bandwidths, while limiting the expanded bandwidth operation to only those times when it provides value for roaming optimization.

In the described techniques, bandwidth expansion is performed on a just-in-time basis to maximize the accuracy of location and trajectory estimates while minimizing overall bandwidth usage and potential interference with adjacent channel BSSs. The bandwidth expansion and corresponding FTM measurements may be performed just before roaming preparation is initiated, enabling an AP to provide accurate target AP recommendations based on current STA location and trajectory. Alternatively, bandwidth expansion and FTM measurements may be performed periodically during defined service periods, allowing the network to maintain an updated estimate of STA location and trajectory that can be used when roaming conditions arise. As another option, bandwidth expansion and FTM measurements may be performed during the roaming preparation exchange itself, allowing real-time refinement of target AP recommendations based on the most current location data. In each case, the bandwidth expansion is targeted to specific STAs or groups of STAs that are likely to roam, rather than applied BSS-wide, further reducing interference and spectrum inefficiency. The coordination of seamless roaming, FTM-based location determination, and dynamic bandwidth mechanisms provides improved roaming success rates and more accurate target AP selection compared to implementations using any of these mechanisms independently.

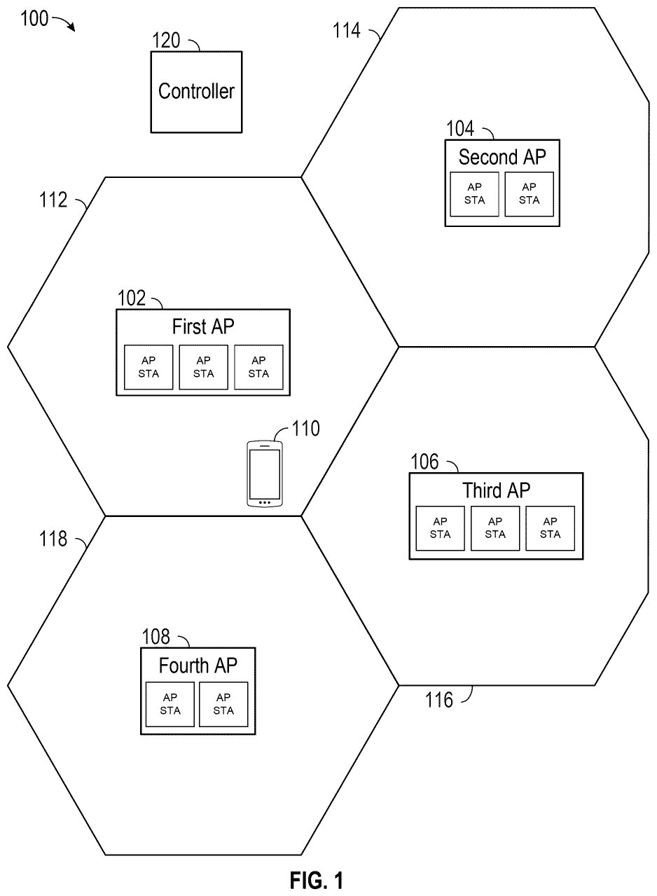

FIG. 1 is a block diagram of an operating environment 100. In the illustrated embodiment, the operating environment 100 includes a first AP 102, a second AP 104, a third AP 106, a fourth AP 108, a STA MLD 110, and a controller 120. The first AP 102 has a service area or cell indicated by the first cell 112. Similarly, the second AP 104 has the second cell 114, the third AP 106 has the third cell 116, and the fourth AP 108 has the fourth cell 118. The range of the first AP 102, the second AP 104, the third AP 106, and the fourth AP 108 may extend past the boundary of the associated cells, resulting in overlapping coverage, but the signals grow weaker as devices move away from respective APs. Thus, the first AP 102, the second AP 104, the third AP 106, and the fourth AP 108 may fail to communicate with devices some distance past the edges of the associated cells. The edges of the first cell 112, the second cell 114, the third cell 116, and the fourth cell 118 as shown in the operating environment 100 are an example and may be different in other implementations (e.g., different sizes, shapes, etc.).

The STA MLD 110 is any device that connects to the network to communicate with other devices on the network, such as a smart phone, a tablet, a personal computer, a server, and/or the like. As illustrated in FIG. 1, the STA MLD 110 is currently within the first cell 112 and associated with the first AP 102. However, the STA MLD 110 may be moving toward the boundary of the first cell 112 and into the second cell 114, indicating that the STA MLD 110 may soon need to roam from the first AP 102 to the second AP 104 or another neighbor AP to maintain network connectivity and quality of service. Traditional roaming decisions are based primarily on RSSI measurements and network recommendations from the serving AP regarding suitable neighbor APs. However, as described herein, the techniques coordinate dynamic bandwidth mechanisms, FTM-based location determination, and seamless roaming procedures to improve the accuracy of roaming decisions and target AP selection.

The controller 120 may be any network controller (e.g., a WLAN controller) and may manage the first AP 102, the second AP 104, the third AP 106, the fourth AP 108, and/or other network devices to allow wireless devices such as the STA MLD 110 to connect to the network. In some embodiments, the operations of the controller 120 described herein may be performed by one or more of the first AP 102, the second AP 104, the third AP 106, the fourth AP 108, and/or another device, and vice versa. The operating environment 100 is an example configuration and there may be a different number of STAs, APs, controllers, and/or other devices in further examples.

The first AP 102, the second AP 104, the third AP 106, and the fourth AP 108 may operate at a baseline operating bandwidth, such as 20 MHz or 40 MHz, which is typical for enterprise deployments. Each of the APs may support dynamic bandwidth mechanisms, such as DBE, DBS, DSO, NPCA, that enable temporary expansion of the operating bandwidth from the baseline bandwidth to a wider bandwidth, such as 160 MHz or 320 MHz. The APs may also support FTM ranging procedures that enable location determination of the STA MLD 110, with the accuracy of the FTM measurements improving with increased bandwidth. Additionally, the APs may support seamless roaming procedures (e.g., as defined in the IEEE 802.11bn amendment), including roaming preparation and roaming execution phases, that enable the STA MLD 110 to transition between APs with reduced roaming latency and data loss. In some embodiments, the first AP 102, the second AP 104, the third AP 106, and the fourth AP 108 are in a same SMD, enabling seamless roaming between them. The techniques described herein coordinate dynamic bandwidth mechanisms, FTM-based location determination, and seamless roaming to optimize roaming accuracy while minimizing the duration and scope of bandwidth expansion to reduce interference with adjacent channel BSSs and preserve spectrum efficiency.

In some embodiments, the first AP 102, the second AP 104, the third AP 106, the fourth AP 108, and/or the STA MLD 110 are MLDs with each including multiple STAs, enabling seamless roaming techniques described in IEEE 802.11bn. Each STA may include Physical (PHY)-layer and lower-Media Access Control (MAC) components. The MLDs may also include an upper-MAC for coordinating the STAs and providing Logical Link Control (LLC). Each STA of a respective MLD may operate on a different channel. For example, the first AP 102 may include multiple AP STAs, with one AP STA operating on one of the channels of the 2.4 Gigahertz (GHz) band, one AP STA operating on a channel of the 5 GHz band, and one AP STA operating on a channel of the 6 GHz band. However, the techniques described herein are not limited to MLD implementations and may be implemented with single-link devices as well.

In some embodiments, the coordination of dynamic bandwidth mechanisms with FTM-based location determination for optimized roaming may be performed selectively for certain STAs based on one or more selection criteria, rather than being applied to all STAs in the network. This selective application enables network resources to be allocated efficiently while ensuring that STAs that would benefit most from accurate location-based roaming receive the enhanced roaming optimization. Selection criteria may include whether the STA has Quality of Service (QoS) flows or Stream Classification Service (SCS) flows active, as STAs with active QoS/SCS flows typically have stricter performance requirements that benefit from optimized roaming with minimal latency and packet loss. Selection criteria may also include whether the STA is classified as a premium client or has a service level agreement that warrants enhanced roaming treatment. Additionally, selection criteria may include RSSI measurements, such as performing bandwidth expansion and FTM-based location determination only when the STA's RSSI with the current AP is above a threshold, indicating that the STA has sufficient signal quality to support the expanded bandwidth operation and FTM measurements. Other selection criteria may include the STA's mobility characteristics (such as velocity or trajectory stability), the STA's capability to support dynamic bandwidth mechanisms and FTM procedures, network congestion levels, and/or interference conditions. By applying these selection criteria, the network can optimize the use of bandwidth expansion and FTM procedures to benefit the STAs that need accurate roaming recommendations while minimizing unnecessary bandwidth expansion that could interfere with adjacent channel BSSs.

For FTM-based location determination trajectory and accuracy optimization, various aspects of the FTM ranging procedure may be specified to optimize roaming performance. The period of ranging bursts (such as 20 milliseconds for voice applications or 17.5 milliseconds for video applications) may be specified to capture a trajectory with a target per-path linear distance or composite angular error. The ranging burst period may be selected based on the expected speed of the STA, last known position of the STA, mobility patterns, and/or other factors that affect trajectory prediction accuracy. Individual ranging burst bandwidth and duration may be selected based on roaming requirements, with higher bandwidth (such as 160 MHz or 320 MHz) and longer duration providing more accurate location measurements at the cost of increased interference and spectrum usage, while lower bandwidth (such as 80 MHz) and shorter duration providing reduced interference at the cost of reduced accuracy. The FTM request may include a reason code that indicates ‘roaming’ or ‘better roaming accuracy’ as the purpose of the FTM procedure. This reason code enables the responding STA (typically an AP) to optimize the FTM configuration by selecting the best role assignment (initiating STA versus responding STA), determining appropriate FTM ranging burst specifications (such as bandwidth, duration, number of bursts, and burst period), and allocating resources to prioritize the roaming-related FTM measurements. By including the roaming-specific reason code in the FTM request, the network can optimize FTM procedures specifically for roaming scenarios, improving both the accuracy of location determination and the efficiency of network resource usage.

For dynamic bandwidth mechanisms such as DBS and DBE, various aspects may be considered when coordinating bandwidth expansion with FTM-based location determination and seamless roaming. Determining which expansion mechanism to use can be based on a period within which roaming is expected to occur. For example, when roaming is expected within approximately one second, bandwidth expansion may be performed via DBS with beacon announcement, providing broader notification of the bandwidth change to all STAs and enabling more coordinated bandwidth expansion. When roaming is more imminent, such as within approximately 100 milliseconds, bandwidth expansion may be performed via DSO or NPCA using group control signaling, enabling faster bandwidth expansion with reduced signaling overhead for a targeted group of STAs. The bandwidth expansion may be targeted to a specific group of capable STAs that are imminently expected to roam, rather than applied BSS-wide or to a single STA. For example, the AP may identify all STAs within a geographic area or coverage boundary that have RSSI measurements indicating potential roaming within a threshold time period, and may expand the bandwidth for this group of STAs synchronously to improve efficiency. The bandwidth expansion may be coordinated with adjacent channel BSSs to minimize interference impact. For example, the AP may determine FTM ranging periods of adjacent channel BSSs and may schedule bandwidth expansion and FTM measurements during time periods when adjacent channel BSSs are not performing FTM ranging or other bandwidth-sensitive operations. This coordination may be performed via inter-AP communication through the DS, via a centralized controller (such as controller 120), and/or via monitoring of beacon frames or other signaling from adjacent channel BSSs. By coordinating bandwidth expansion timing with adjacent channel BSS operations, the network can minimize co-channel interference and adjacent channel interference while still enabling high-accuracy FTM-based location determination for roaming optimization.

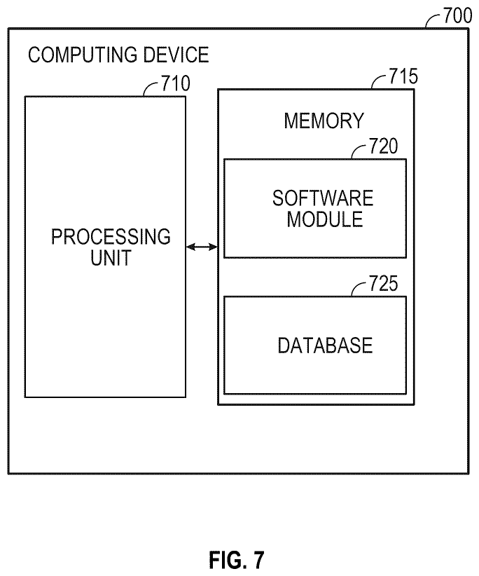

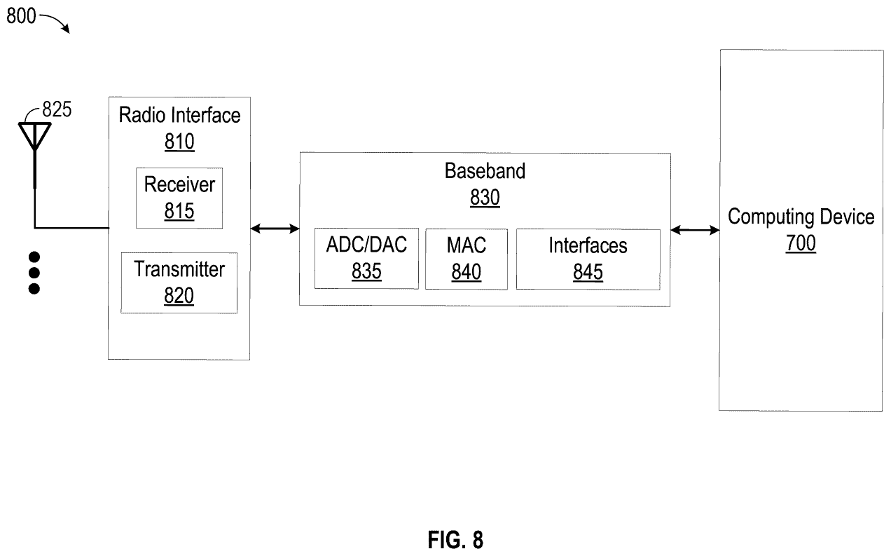

The elements described above of the operating environment 100 (e.g., the first AP 102, the second AP 104, the third AP 106, the fourth AP 108, the STA MLD 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 7 and 8, the elements of the operating environment 100 may be practiced in a computing device 700 and/or communications device 800.

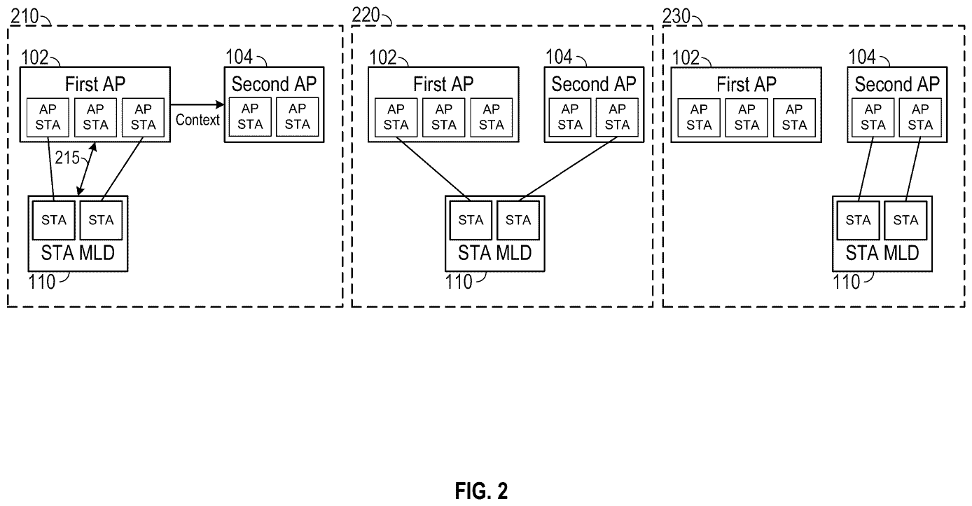

FIG. 2 illustrates an example seamless roaming process with the STA MLD 110 roaming from the first AP 102 to the second AP 104. The seamless roaming process includes three phases: a preparation phase 210, a during roaming phase 220, and an after roaming phase 230. The preparation phase 210 enables the STA MLD 110 and the first AP 102 to prepare one or more target APs for an upcoming roaming transition, the during roaming phase 220 enables the STA MLD 110 to establish one or more links with a target AP while maintaining one or more links with the first AP 102, and the after roaming phase 230 occurs after the STA MLD 110 has deleted all links with the first AP 102 and established one or more links with the second AP 104 (the selected target AP).

During the preparation phase 210, the STA MLD 110 and the first AP 102 perform a seamless transition (ST) exchange 215. The ST exchange 215 includes an ST request sent from the STA MLD 110 to the first AP 102, indicating that the STA MLD 110 intends to roam to one or more target APs. In response to the ST request, the first AP 102 sends context related to the STA MLD 110 to the second AP 104 and potentially other target APs for setting up one or more links between the STA MLD 110 and the target AP(s). The context transferred may include parameters related to block acknowledgement agreements setup for the STA MLD 110, stream classification service (SCS) streams setup for the STA MLD 110, mirrored stream classification service (MSCS) streams setup for the STA MLD 110, target wake time (TWT) agreements setup for the STA MLD 110, TID-to-link mapping (TTLM) agreements setup for the STA MLD 110, security association context associated with the STA MLD 110, capabilities of the STA MLD 110, and/or other context information. The ST exchange 215 further includes an ST response sent from the first AP 102 to the STA MLD 110 indicating whether the roaming request succeeds, for example indicating whether one or more target APs accept the roaming request. If at least one target AP accepts the roaming request (the second AP 104 in the illustrated embodiment), the preparation phase 210 is considered successful. The ST exchange 215 can further include additional ST requests, context transfers, and ST responses if the roaming request fails or to provide multiple options to the STA MLD 110. The preparation phase 210 can include any operations described in various IEEE 802.11 specifications and amendments, including the IEEE 802.11bn amendment.

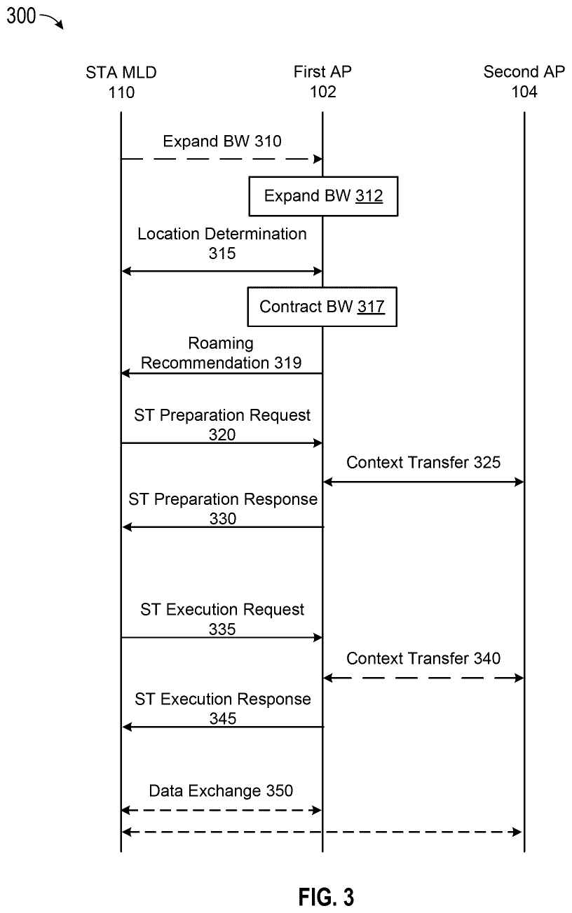

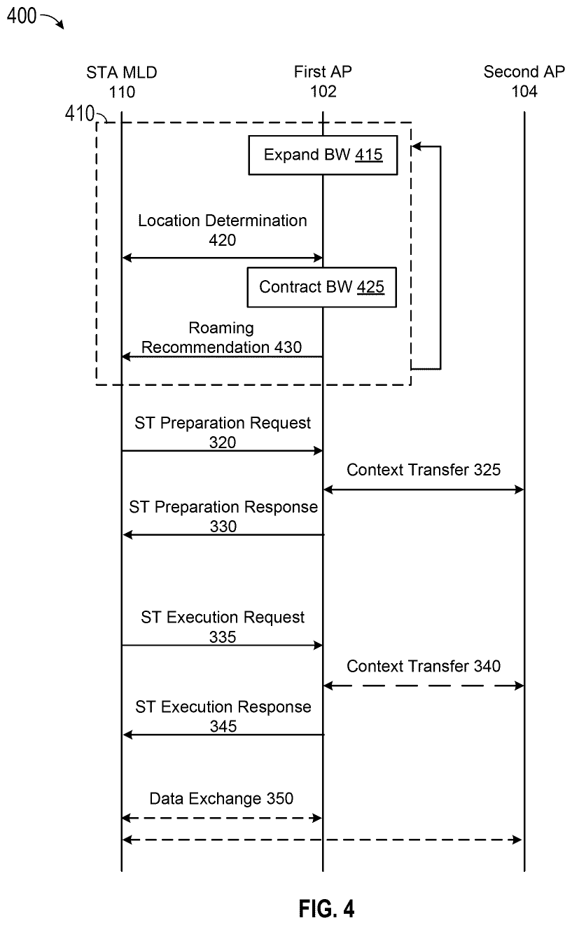

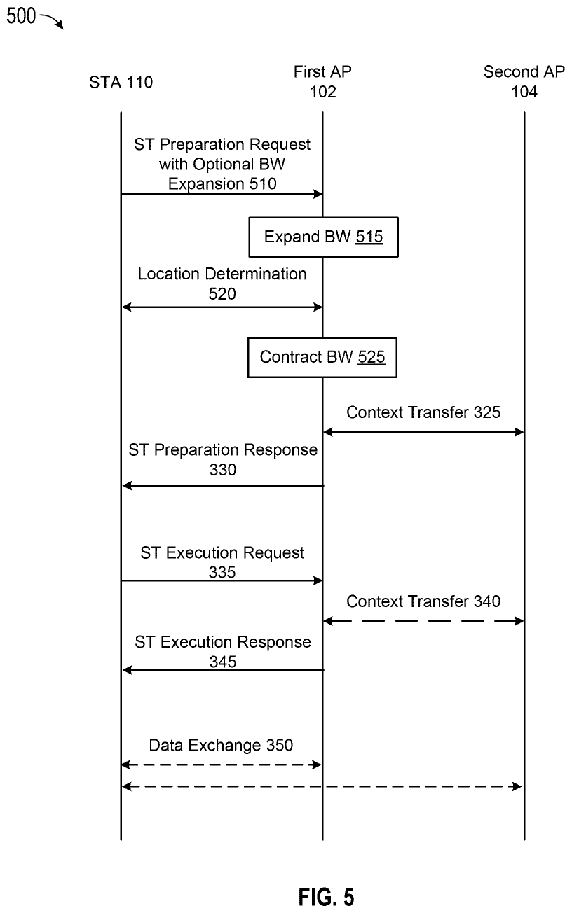

To determine which AP the STA MLD 110 should roam to and which target AP or APs to transfer context to during the preparation phase 210, the first AP 102 may utilize accurate location and trajectory information for the STA MLD 110. As described with respect to FIGS. 3-5, the first AP 102 and/or the STA MLD 110 can coordinate dynamic bandwidth mechanisms with location determination processes according to any of three procedures: performing bandwidth expansion and location determination just before the preparation phase 210 (FIG. 3), performing periodic bandwidth expansion and location determination with just-in-time use of the location information before the preparation phase 210 (FIG. 4), or performing bandwidth expansion and location determination as part of the ST exchange 215 during the preparation phase 210 (FIG. 5). Each procedure enables the first AP 102 to obtain accurate location and trajectory information for the STA MLD 110 by performing measurements at an expanded bandwidth while limiting the duration of bandwidth expansion to minimize interference with adjacent channel BSSs and preserve spectrum efficiency.

Following successful completion of the preparation phase 210, the first AP 102 and the STA MLD 110 can perform the roaming execution phase to enable the STA MLD 110 to enter the during roaming phase 220. In the during roaming phase 220, the STA MLD 110 has established at least one link with the second AP 104 (the target AP) while maintaining at least one link with the first AP 102. This “make-before-break” procedure enables continuous connectivity during the roaming transition, avoiding connection drops and data loss. Once the STA MLD 110 completes the roaming transition and deletes all links with the first AP 102, the STA MLD 110 enters the after roaming phase 230, where the STA MLD 110 maintains one or more links with the second AP 104 and no longer has any links with the first AP 102.

FIG. 3 is a message exchange diagram illustrating a first procedure 300 for coordinating dynamic bandwidth mechanisms with FTM-based location determination to optimize seamless roaming. In this first procedure 300, bandwidth expansion and location determination are performed just before roaming preparation is initiated, enabling the first AP 102 to provide accurate target AP recommendations based on current location and trajectory information for the STA MLD 110.

At some point prior to the message exchanges illustrated in FIG. 3, the STA MLD 110 may determine to initiate a seamless roaming process. Initiating a seamless roaming process by the STA MLD 110 may be triggered upon receiving a report from the first AP 102 (current AP). Such report may be generated based on observed network conditions and parameters associated with the quality of connection of the STA MLD 110 with the first AP 102 and/or other APs that are available. Alternatively, the STA MLD 110 may determine to initiate seamless roaming based on RSSI measurements, trajectory predictions, or other factors. Upon making this determination, the STA MLD 110 may optionally perform initial signaling exchange with the first AP 102, such as requesting a Neighbor Report from the first AP 102 that includes identification of several available target APs. However, in certain embodiments, retrieval of such information may be delayed until after location determination is performed (as described below with respect to stage 319) to enable the first AP 102 to provide more accurate target AP recommendations based on the location determination.

Once the STA MLD 110 determines to initiate seamless roaming, the STA MLD 110 sends a request to expand the bandwidth to the first AP 102 in stage 310. The request to expand the bandwidth may request expansion from a baseline operating bandwidth (such as 20 MHz or 40 MHz) to a wider bandwidth (such as 160 MHz or 320 MHz) to enable high-accuracy FTM-based or ultra-wideband-based location determination. The request to expand the bandwidth in stage 310 may include a reason code indicating the purpose of the bandwidth expansion, such as ‘BW Expansion for better roaming accuracy with location measurement’. The request to expand the bandwidth in stage 310 may also include a time period for the expanded bandwidth operation, such as one second or another duration sufficient to perform the location determination procedure. The request to expand the bandwidth in stage 310 may be implemented using any dynamic bandwidth mechanism, such as DBE DBS, DSO, and NPCA. In some embodiments, the first AP 102 may expand the bandwidth for a group of STAs in synchronization if multiple STAs request expanding the bandwidth for roaming optimization purposes, further improving efficiency of the bandwidth expansion procedure. In another embodiment, the first AP 102 itself can trigger bandwidth expansion and FTM-based (or ultra-wideband-based) location/trajectory measurements based on determining that one or more STAs (including the STA MLD 110) have their uplink RSSI degraded beyond a threshold. In such a case, the first AP 102 can trigger bandwidth expansion in operation 312 just for these STAs using DBS signaling or other dynamic bandwidth mechanism signaling for bandwidth expansion for one or more STAs, without requiring the STA MLD 110 to send the request to expand the bandwidth in stage 310. The first AP 102 can then trigger FTM (or ultra-wideband) measurements for these STAs in the location determination in exchange 315 described below. Based on FTM (or ultra-wideband) based location/trajectory estimation, the first AP 102 then selects more accurate candidate target APs for roaming and provides a recommendation in stage 319 to the STA MLD 110 as described below.

In another embodiment, more optimized signaling for dynamic bandwidth mechanisms and FTM for optimized roaming can be performed where the location determination in exchange 315 can be enhanced to also signal dynamic bandwidth expansion. In this case, a single set of request/response signaling can be used to start the location determination in exchange 315 (e.g., FTM) and the same signaling can also trigger temporary dynamic bandwidth expansion for a sufficient time duration for performing FTM (or ultra-wideband) measurements for optimized roaming. The FTM signaling can indicate the reason for FTM and dynamic bandwidth expansion as ‘better roaming accuracy.’ This enhanced signaling procedure eliminates the need for separate bandwidth expansion request in stage 310 and location determination in exchange 315, instead combining these operations into a single signaling exchange. The enhanced FTM request may include both FTM parameters (such as number of bursts, burst duration, etc.) and bandwidth expansion parameters (such as target bandwidth, duration of expansion, etc.). In response to the enhanced FTM request, the first AP 102 may expand the bandwidth and perform the FTM procedure, then contract the bandwidth upon completion of the FTM measurements. The first procedure 300 reduces signaling overhead and latency compared to separate bandwidth expansion and FTM procedures.

In response to the request to expand the bandwidth in stage 310, the first AP 102 expands the bandwidth at operation 312 from the baseline operating bandwidth to the wider bandwidth. The bandwidth expansion may be targeted to the STA MLD 110 or a group of STAs that are about to roam, rather than applied BSS-wide, to minimize interference with adjacent channel BSSs and preserve spectrum efficiency. Since the bandwidth expansion is performed for a specific STA or group of STAs that are about to roam, the bandwidth expansion need not be announced in Beacon frames, Probe Response frames, or other broadcast signaling.

With the expanded bandwidth enabled, the first AP 102 and the STA MLD 110 perform location determination in exchange 315. The location determination in exchange 315 may be FTM-based location determination, ultra-wideband location determination, or another ranging technique for increased accuracy. For FTM-based location determination, the STA MLD 110 or the first AP 102 may initiate an FTM procedure that includes exchange of FTM frames and Acknowledge (ACK) frames to enable measurement of times of flight of the messages. The FTM request may include an indication of ‘better roaming accuracy’ as a reason for performing FTM. The location determination in exchange 315 performed over the expanded bandwidth provides significantly improved accuracy compared to location determination performed at the baseline operating bandwidth, enabling more accurate trajectory prediction and target AP selection. The location determination in exchange 315 may involve FTM exchanges between the STA MLD 110 and multiple APs, including the first AP 102 and one or more of the second AP 104, third AP 106, and fourth AP 108, to enable trilateration or multilateration techniques for determining the location of the STA MLD 110.

Once the location determination in exchange 315 is complete, the first AP 102 contracts the bandwidth at operation 317, returning from the expanded bandwidth to the baseline operating bandwidth. In one embodiment, the bandwidth may automatically contract to the baseline operating bandwidth upon completion of the location determination in exchange 315 or upon expiration of the time period specified in the request to expand the bandwidth in stage 310. In another embodiment, additional signaling may be exchanged between the STA MLD 110 and the first AP 102 to change the bandwidth back to the baseline operating bandwidth.

Based on the location and trajectory information obtained during the location determination in exchange 315, the first AP 102 performs an AP recommendation procedure in stage 319 to provide the STA MLD 110 with accurate target AP recommendations. The AP recommendation procedure in stage 319 may include sending a Neighbor Report to the STA MLD 110 that includes identification of one or more candidate target APs, sending a BSS Transition Management (BTM) Request to the STA MLD 110 suggesting one or more candidate target APs, and/or sending a Link Reconfiguration Notify frame to the STA MLD 110 identifying one or more candidate target APs. The target AP recommendations provided in the AP recommendation procedure in stage 319 are based on the accurate location and trajectory information obtained during the location determination in exchange 315, enabling the first AP 102 to suggest target APs that are along the STA MLD 110's predicted path and avoid suggesting target APs that the STA MLD 110 is moving away from. If initial signaling exchange (such as a Neighbor Report request and response) was performed before the location determination in exchange 315, the AP recommendation procedure in stage 319 may update that information with more accurate target AP recommendations based on the location determination in exchange 315.

Following the AP recommendation procedure in stage 319, the STA MLD 110 sends an ST preparation request in stage 320 to the first AP 102. The ST preparation request in stage 320 may include a list of desired candidate target APs determined by the STA MLD 110 from the AP recommendation procedure in stage 319. The ST preparation request may be implemented as a Roaming Notification, a Link Reconfiguration request, or another signaling frame. For example, the Link Reconfiguration request may include one or more Reconfiguration ML element(s) indicating links for setup with one or more candidate target AP MLDs along with a preference order of desired candidates. The ST preparation request may further include a Seamless Mobility Domain Element (SMDE) identifying the Seamless Mobility Domain (SMD), a set of Roaming control information that includes a preparation indication, a Roaming Sequence Number, a context transfer indication indicating the set of contexts to be transferred, a resource reservation request, a context negotiation request, and/or other information.

After receiving the ST preparation request in stage 320, the first AP 102 may determine a final list of candidate target APs. This list may include the second AP 104 and potentially other target APs. Once the list is determined, the first AP 102 performs context transfer in exchange 325 with the candidate target APs (including the second AP 104) to transfer one or more static context parameters and reserve resources on the candidate target APs, and/or to perform negotiation of one or more static context parameters with the candidate target APs and to setup link(s) with the candidate target APs. The context transfer may include transfer of near static context (or any selected context information) to one or more candidate target APs for roaming in the future, pre-setting up links on one or more candidate target APs (with the links not yet activated and 802.1x port not yet open for data transfer), and optional resource reservation for one or more resources on the candidate target APs for a time period (such as a Roaming Execution Timer duration). The resources reserved may include pre-assignment of setup links for the STA MLD 110, reserving Quality of Service (QoS) resources for one or more SCS streams as requested by the STA MLD 110 or selected by the first AP 102, reserving resources for TWT agreements (either existing TWT agreements that are requested to be transferred to specific links or new TWT agreements that are requested to be negotiated), reserving Block Acknowledgment resources, and/or reserving any other resources requested by the STA MLD 110 or selected by the first AP 102. The context transferred may include parameters related to block acknowledgement agreements setup for the STA MLD 110, SCS streams setup for the STA MLD 110, MSCS streams setup for the STA MLD 110, TWT agreements setup for the STA MLD 110, TTLM agreements setup for the STA MLD 110, security association context associated with the STA MLD 110, capabilities of the STA MLD 110, and/or other context information. The static context to be transferred to candidate target APs may be specified by the STA MLD 110 and the first AP 102 (negotiated between them).

Following the context transfer in exchange 325, the first AP 102 sends an ST preparation response in stage 330 to the STA MLD 110. The ST preparation response may include an indication of one or more candidate target APs (such as a list of candidate target APs that may be listed in preference order), an indication of a set of one or more static context parameters that were transferred to the candidate target APs, an indication of one or more context parameters that were negotiated with the candidate target APs, an indication of resources reserved at the candidate target APs, and/or a Roaming Allowance Duration (RAD) or Roaming Execution Timer value. In embodiments where a Link Reconfiguration Request is used for roaming preparation, a corresponding Link Reconfiguration Response may include ML element(s) (e.g., Basic Multi-link element or Reconfiguration ML element) for one or more target APs, an SMD element, Roaming Control information that includes one or more of status (e.g., accept/reject) for roaming preparation, a roaming preparation indication, a Roaming Sequence Number, context transfer indication that indicates the set of context that were transferred, context negotiation indication that indicates one or more context parameters that were negotiated with the candidate target APs, resource reservation indication indicating the set of resources reserved, RAD/Roaming Execution Timer, and/or other information. The Roaming Sequence Number may be used to tie the roaming preparation phase with a subsequent roaming execution phase. If at least one candidate target AP (the second AP 104 in the illustrated embodiment) accepts the roaming request, the preparation phase is considered successful. Once the ST preparation response is received by the STA MLD 110, the roaming preparation phase may be considered complete.

Thereafter, the STA MLD 110 may determine a target AP to roam to from among the list of candidate target APs received as part of the ST preparation response. For example, the STA MLD 110 may select the second AP 104 as the target AP to roam to. This determination may be based on RSSI measurements, location and trajectory information, channel load observations, preference order provided in the ST preparation response, and/or other factors. Once the STA MLD 110 determines the target AP, the roaming execution phase may be triggered when the STA MLD 110 sends an ST execution request in stage 335 to the first AP 102.

Using the ST execution request, the STA MLD 110 may send a roaming execution request (e.g., an Add Link Request, a Link Reconfiguration request, etc.) to the first AP 102 to request roaming to the selected target AP (the second AP 104) along with one or more requested links to be established with the target AP. The set of links requested may be the same as the links setup in the roaming preparation phase with the target AP. In such a case, the STA MLD 110 may omit including the set of links again and indicate to perform roaming with the links that are already setup in the roaming preparation phase. The ST execution request may include a Reconfiguration ML element for the target AP, an SMDE, and Roaming control information that includes one or more of a field for execution indication, a Roaming Sequence Number to tie the roaming execution phase with the roaming preparation phase, a context transfer indication indicating set of context to be transferred, context negotiation indication that indicates one or more context parameters to negotiate with the target AP, and/or other information.

After the first AP 102 receives the ST execution request in stage 335, optional context transfer in exchange 340 may take place between the first AP 102 and the target AP (the second AP 104). This exchange may be performed according to any known or to be developed signaling procedure whereby the first AP 102 confirms the roaming with the selected target AP and exchanges dynamic context (e.g., Sequence Number (SN) and/or Packet Number (PN)) with the selected target AP. During the dynamic context transfer, in parallel, the target AP (the second AP 104) may initiate a Distribution System (DS) mapping change to switch the data path for the STA MLD 110 from the first AP 102 to the second AP 104. The DS mapping change may be completed via signaling exchange between the second AP 104 and the DS, enabling the network to route data traffic for the STA MLD 110 to the second AP 104 rather than the first AP 102.

Once the DS mapping update has been initiated for data path switch for the STA MLD 110, the first AP 102 sends an ST execution response in stage 345 to the STA MLD 110 to confirm that roaming execution and dynamic context transfer as part of that process is complete. The ST execution response may be implemented as an Add Link response, Link reconfiguration response, or other signaling frame. The ST execution response may include one or more ML element(s) (e.g., Basic ML element or Reconfiguration ML element) for the target AP (the second AP 104), an SMDE, Roaming control information indicating status of the roaming execution (e.g., accept/reject), an execution phase indication, a Roaming Sequence Number, a context transfer indication indicating set of context that were transferred to the target AP, Group Keys of the links setup with the target AP, an Association Identifier (AID) assigned to the STA MLD 110 by the target AP, and/or other information.

Following the ST execution response in stage 345, the first AP 102 may optionally cancel resources reserved on other candidate target APs (which occurred along with static context transfer during the context transfer in exchange 325). Alternatively, the resource reservation (and links setup) on other candidate target APs can expire automatically (e.g., upon expiration of a timer which may be the same or different than the RAD). The first AP 102 may also optionally send a Roaming Delete Link message to the STA MLD 110 to delete existing link(s) between the first AP 102 and the STA MLD 110. In another embodiment, the explicit link deletion step may be skipped and link deletion may be done implicitly based on a timer value specified by the first AP 102 in the ST execution response.

At this point, the STA MLD 110 may perform data exchange 350 with the second AP 104 and potentially with the first AP 102 during the “make-before-break” roaming transition. The data exchange 350 may include uplink and downlink transmissions between the STA MLD 110, the second AP 104, and the DS. Once the STA MLD 110 completes the roaming transition and deletes all links with the first AP 102, the STA MLD 110 continues data exchange 350 with the second AP 104.

While FIG. 3 illustrates the second AP 104 as the target AP, in other embodiments one or more APs may be target APs, and the STA MLD 110 may establish links with multiple target APs during the roaming transition. Additionally, in a multi-phased roaming procedure, after the roaming preparation phase is complete, the roaming execution phase may be canceled for any number of reasons. For instance, the STA MLD 110 may change its target AP selection due to changes the STA MLD 110 observes in RSSI and/or channel load of the first AP 102 or other neighboring APs. In this case, the STA MLD 110 may desire to cancel the previous roaming preparation and start another roaming procedure (roaming preparation plus roaming execution phases). To do so, the STA MLD 110 may use the Roaming Sequence Number to signal that the STA MLD 110 is starting a new roaming procedure. The STA MLD 110 may increment its Roaming Sequence Number and use that value in the next roaming procedure the STA MLD 110 starts with the first AP 102. When the first AP 102 receives a roaming preparation request or a roaming execution request with an incremented Roaming Sequence Number, that also signals to the first AP 102 to implicitly cancel the previous roaming preparation performed by the STA MLD 110. Therefore, the Roaming Sequence Number can be used to implicitly cancel a previous roaming preparation phase when the STA MLD 110 wants to change its roaming selection and start a new roaming procedure with a different set of target APs. In another embodiment, the STA MLD 110 may send explicit signaling to the first AP 102 to cancel a previous roaming preparation if it desires to start another roaming procedure.

In some embodiments, the request to expand the bandwidth in stage 310, bandwidth expansion in operation 312, location determination in exchange 315, and bandwidth contraction in operation 317 may be performed after the ST preparation response in stage 330 and before the ST execution request in stage 335. This timing enables the STA MLD 110 to obtain updated location and trajectory information after the roaming preparation phase is complete but before the roaming execution phase begins, allowing the STA MLD 110 to select the best candidate target AP from among the list of candidate target APs provided in the ST preparation response based on current location data. For example, if a delay occurs between the completion of roaming preparation and the initiation of roaming execution, the STA MLD 110 may have moved significantly, and an updated location determination may reveal that a different target AP is now more appropriate. By performing bandwidth expansion and location determination between the preparation and execution phases, the roaming decision can be updated based on the most current location and trajectory information, improving roaming success rates and quality of service.

FIG. 4 is a message exchange diagram illustrating a second procedure 400 for coordinating dynamic bandwidth mechanisms with FTM-based location determination to optimize seamless roaming. In this second procedure 400, bandwidth expansion and location determination are performed periodically during defined service periods, enabling the first AP 102 to maintain an updated estimate of the STA MLD 110's location and trajectory that can be used when roaming conditions arise. The second procedure 400 enables the first AP 102 to always have better estimation of the STA MLD 110's location and trajectory and to use that information to provide suggestions for candidate target APs for roaming on a just-in-time basis when the STA MLD 110 determines to roam.

As illustrated in FIG. 4, the first AP 102 and the STA MLD 110 perform one or more periodic location determination processes 410. Each periodic location determination process 410 occurs during a service period (SP) that is established between the first AP 102 and the STA MLD 110. The service period may be established via SCS QoS Characteristics, Target Wake Time (TWT), Restricted TWT (R-TWT), or similar mechanism independently of FTM procedures. The service period should have a sufficiently high frequency to capture mobility of the STA MLD 110, for example 20 milliseconds for voice applications, 17.5 milliseconds for video applications, or other appropriate intervals based on the expected mobility characteristics of the STA MLD 110. The service period may be defined as a bi-directional cascade such that the range request (e.g., from the first AP 102 to the STA MLD 110) and response (e.g., from the STA MLD 110 to the first AP 102) are highly correlated in time, such as separated by a Short Interframe Space (SIFS). In some embodiments, the FTM request and response may be embedded into IEEE 802.11 Aggregated Control (A-CTRL) fields to further reduce signaling overhead.

Each periodic location determination process 410 includes several steps. First, the first AP 102 expands the bandwidth in operation 415 for one or more STAs, including the STA MLD 110. The bandwidth expansion comprises expanding from a baseline operating bandwidth (such as 20 MHz or 40 MHz) to a wider bandwidth (such as 160 MHz or 320 MHz) to enable high-accuracy FTM-based or ultra-wideband-based location determination. The bandwidth expansion may be performed using any dynamic bandwidth mechanism, such as DBE, DBS, DSO, or NPCA. The first AP 102 may expand the bandwidth for a group of STAs in synchronization if multiple STAs are scheduled for periodic location determination during the same service period, further improving efficiency of the bandwidth expansion procedure. The bandwidth expansion may be limited to the duration of the service period to minimize interference with adjacent channel BSSs and preserve spectrum efficiency.

With the expanded bandwidth enabled, the first AP 102 and the STA MLD 110 perform location determination in exchange 420. The location determination may be FTM-based location determination, ultra-wideband location determination, or another ranging technique. The location determination performed over the expanded bandwidth provides significantly improved accuracy compared to location determination performed at the baseline operating bandwidth, enabling more accurate trajectory prediction. The location determination may involve FTM exchanges between the STA MLD 110 and multiple APs to enable trilateration or multilateration techniques for determining the location of the STA MLD 110. Because the location determination occurs during the defined service period with the range request and response highly correlated in time, the measurement procedure can be completed efficiently with minimal overhead.

Once the location determination in exchange 420 is complete, the first AP 102 contracts the bandwidth in operation 425, returning from the expanded bandwidth to the baseline operating bandwidth. The bandwidth contraction may occur automatically upon completion of the location determination in exchange 420 or upon expiration of the service period.

Based on the location and trajectory information obtained during the location determination, the first AP 102 may provide roaming recommendation in stage 430 to the STA MLD 110. The roaming recommendation may include identification of one or more candidate target APs that are along the STA MLD 110's predicted path based on the trajectory analysis. The roaming recommendation may be provided using a Neighbor Report, a BTM Request, a Link Reconfiguration Notify frame, or other signaling. Because the periodic location determination processes 410 are performed regularly, the first AP 102 maintains current location and trajectory information for the STA MLD 110, enabling the roaming recommendation to be highly accurate and up-to-date.

The periodic location determination processes 410 may be performed multiple times as illustrated in FIG. 4, with each iteration providing updated location and trajectory information to the first AP 102. The frequency of the periodic location determination processes 410 may be adjusted based on the mobility characteristics of the STA MLD 110, network conditions, and other factors. For highly mobile STAs, the periodic location determination processes 410 may be performed more frequently to maintain accurate trajectory predictions. For relatively stationary STAs, the periodic location determination processes 410 may be performed less frequently to conserve network resources and minimize bandwidth expansion overhead.

At some point, the STA MLD 110 may determine to initiate a seamless roaming process based on RSSI measurements, roaming recommendations received from the first AP 102, or other factors. When the STA MLD 110 determines to roam, it has access to the roaming recommendation from the most recent periodic location determination process 410 and can use that information to identify candidate target APs. The STA MLD 110 then sends an ST preparation request in stage 320 to the first AP 102 to initiate the roaming preparation phase.

Following the ST preparation request in stage 320, the first AP 102 and the STA MLD 110 perform the context transfer in exchange 325, ST preparation response in stage 330, ST execution request in stage 335, optional context transfer in exchange 340, ST execution response in stage 345, and data exchange 350 as described in detail with respect to FIG. 3. Because the first AP 102 already has accurate and current location and trajectory information for the STA MLD 110 from the periodic location determination processes 410, the first AP 102 can immediately provide accurate target AP recommendations and perform context transfer with appropriate candidate target APs without needing to perform additional bandwidth expansion and location determination procedures at the time of roaming. The second procedure 400 enables seamless roaming to proceed efficiently while still benefiting from the improved accuracy of wide-bandwidth FTM measurements.

In some embodiments, the periodic location determination process 410 may be performed after the ST preparation response in stage 330 and before the ST execution request in stage 335. This timing enables the STA MLD 110 or the first AP 102 to obtain updated location and trajectory information after the roaming preparation phase is complete but before the roaming execution phase begins. If the most recent periodic location determination process 410 occurred a significant time before the ST preparation response in stage 330 that could lead to inaccurate location data, performing an additional periodic location determination process 410 between the preparation and execution phases enables the STA MLD 110 to select the best candidate target AP from among the list of candidate target APs provided in the ST preparation response based on current location data. The second procedure 400 combines the efficiency of periodic location tracking with just-in-time location verification before roaming execution, ensuring that the roaming decision is based on accurate and current information while maintaining the benefits of regular trajectory monitoring.

FIG. 5 is a message exchange diagram illustrating a third procedure 500 for coordinating dynamic bandwidth mechanisms with FTM-based location determination to optimize seamless roaming. In this third procedure 500, bandwidth expansion and location determination are performed as part of the ST exchange during the roaming preparation phase, enabling the first AP 102 to obtain accurate location and trajectory information and provide accurate target AP recommendations in the roaming preparation response based on the most current location data.

At some point prior to the message exchanges illustrated in FIG. 5, the STA MLD 110 may determine to initiate a seamless roaming process as described with respect to FIG. 3. The STA MLD 110 then sends an ST preparation request in stage 510 with an optional request for bandwidth expansion to the first AP 102. The ST preparation request may include a list of desired candidate target APs determined by the STA MLD 110, and may be implemented as a Roaming Notification, a Link Reconfiguration request, or another signaling frame. The ST preparation request may include one or more Reconfiguration ML element(s) indicating links for setup with one or more candidate target AP MLDs along with a preference order of desired candidates. The ST preparation request may further include an SMD element identifying the SMD, a set of Roaming control information that includes a preparation indication, a Roaming Sequence Number, a context transfer indication indicating the set of contexts to be transferred, a resource reservation request, a context negotiation request, and/or other information.

Additionally, the ST preparation request may optionally include a request for bandwidth expansion to enable accurate location determination. The request for bandwidth expansion may request expansion from a baseline operating bandwidth (such as 20 MHz or 40 MHz) to a wider bandwidth (such as 160 MHz or 320 MHz). The request for bandwidth expansion may include a reason code indicating the purpose of the bandwidth expansion, such as ‘BW Expansion for better roaming accuracy with location measurement’. The request for bandwidth expansion may also include a time period for the expanded bandwidth operation, such as a duration sufficient to perform the location determination procedure. In embodiments where the STA MLD 110 does not include a request for bandwidth expansion in the ST preparation request, the first AP 102 may itself determine to expand the bandwidth and perform FTM (or ultra-wideband) measurements after receiving the ST preparation request in stage 510 from the STA MLD 110. This determination may be based on network conditions, the need for accurate target AP selection, trajectory prediction requirements, and/or other factors.

In response to the ST preparation request in stage 510, the first AP 102 expands the bandwidth in operation 515 from the baseline operating bandwidth to the wider bandwidth. The bandwidth expansion may be performed in response to the optional request for bandwidth expansion included in the ST preparation request, or may be initiated by the first AP 102 itself after receiving the ST preparation request in stage 510 and determining that bandwidth expansion is appropriate for accurate location determination. The bandwidth expansion may be implemented using any dynamic bandwidth mechanism, such as DBE, DBS, DSO, or NPCA. The bandwidth expansion may be targeted to the STA MLD 110 or a group of STAs to minimize interference with adjacent channel BSSs and preserve spectrum efficiency.

With the expanded bandwidth enabled, the first AP 102 and the STA MLD 110 perform location determination in exchange 520. The location determination may be FTM-based location determination, ultra-wideband location determination, or another ranging technique. For FTM-based location determination, the STA MLD 110 or the first AP 102 may initiate an FTM procedure that includes exchange of FTM frames and ACK frames to enable measurement of times of flight of the messages. The FTM request may include an indication of ‘better roaming accuracy’ as a reason for performing FTM. The location determination performed over the expanded bandwidth provides significantly improved accuracy compared to location determination performed at the baseline operating bandwidth, enabling more accurate trajectory prediction and target AP selection. The location determination may involve FTM exchanges between the STA MLD 110 and multiple APs to enable trilateration or multilateration techniques for determining the location of the STA MLD 110.

Once the location determination in exchange 520 is complete, the first AP 102 contracts the bandwidth in operation 525, returning from the expanded bandwidth to the baseline operating bandwidth. The bandwidth contraction in operation 525 may occur automatically upon completion of the location determination in exchange 520 or upon expiration of the time period specified for the bandwidth expansion.

Based on the location and trajectory information obtained during the location determination in exchange 520, the first AP 102 determines a final list of candidate target APs for the STA MLD 110. This list may include the second AP 104 and potentially other target APs, and may be ordered based on preference. The target AP recommendations are based on the accurate location and trajectory information obtained during the location determination in exchange 520, enabling the first AP 102 to suggest target APs that are along the STA MLD 110's predicted path and avoid suggesting target APs that the STA MLD 110 is moving away from. Unlike the procedures illustrated in FIGS. 3 and 4, no separate roaming recommendation is provided before the ST preparation response in stage 330 because the accurate target AP recommendations will be included in the ST preparation response itself.

Once the list of candidate target APs is determined based on the location determination in exchange 520, the first AP 102 performs context transfer in exchange 325 with the candidate target APs (including the second AP 104) as described in detail with respect to FIG. 3. The context transfer includes transfer of static context parameters, resource reservation on the candidate target APs, and/or pre-setting up links with the candidate target APs.

Following the context transfer in exchange 325, the first AP 102 sends the ST preparation response in stage 330 to the STA MLD 110. The ST preparation response includes an indication of one or more candidate target APs (such as a list of candidate target APs listed in preference order based on the location and trajectory information), an indication of a set of one or more static context parameters that were transferred to the candidate target APs, an indication of one or more context parameters that were negotiated with the candidate target APs, an indication of resources reserved at the candidate target APs, and/or a RAD or Roaming Execution Timer value. The candidate target APs identified in the ST preparation response are selected based on the accurate location and trajectory information obtained during the location determination in exchange 520, providing improved accuracy compared to target AP recommendations based solely on RSSI measurements or location information obtained at narrow bandwidth. In one embodiment, when the FTM procedure performed during the location determination in exchange 520 takes longer than expected, the first AP 102 can send a follow-up response to the STA MLD 110 to indicate more accurate suggestions for roaming candidate target APs. This follow-up response enables the first AP 102 to initially provide a preliminary ST preparation response based on available information, then update the recommendations once the complete location determination in exchange 520 is finished, balancing the need for timely roaming preparation with the desire for highly accurate target AP selection.

Following the ST preparation response, the STA MLD 110 and the first AP 102 perform the ST execution request in stage 335, optional context transfer in exchange 340, ST execution response in stage 345, and data exchange 350 as described in detail with respect to FIG. 3. The STA MLD 110 selects a target AP from among the candidate target APs identified in the ST preparation response, sends the ST execution request identifying the selected target AP, receives the ST execution response confirming the roaming execution, and begins data exchange with the selected target AP (the second AP 104 in the illustrated embodiment).

The third procedure 500 provides the advantage of performing location determination at the exact time when roaming preparation occurs, ensuring that the target AP recommendations are based on the most current location and trajectory information available. The third procedure 500 may be particularly beneficial when the STA MLD 110's movement is unpredictable or when network conditions change rapidly, as the location determination in exchange 520 is performed immediately before the context transfer in exchange 325 and ST preparation response in stage 330, minimizing the time between location measurement and target AP recommendation. However, the third procedure 500 may introduce slightly longer latency for the roaming preparation phase compared to the procedures 300, 400 illustrated in FIGS. 3 and 4, as the roaming preparation phase must wait for the completion of the location determination in exchange 520 before the ST preparation response can be sent.

The three procedures illustrated in FIGS. 3, 4, and 5 for coordinating seamless roaming, dynamic bandwidth mechanisms, and FTM-based location determination are not mutually exclusive and may be utilized individually or in combination based on various considerations. In some cases, the selection of which procedure to use may depend on client algorithms implemented by the STA MLD 110. For example, if the client algorithms encompass the capability to request bandwidth expansion just before roaming preparation (as in FIG. 3), the STA MLD 110 may initiate that procedure. However, if the client algorithms do not include such capabilities, the first AP 102 may need to initiate bandwidth expansion using the first procedure 300, the second procedure 400, and/or the third procedure 500. Additionally, multiple procedures may be used for the same roaming event. For example, the first AP 102 and STA MLD 110 may perform periodic location determination processes as described with respect to the second procedure 400, but may also perform additional bandwidth expansion and location determination just before roaming preparation as in the first procedure 300 or between preparation and execution if updated location information is needed due to time elapsed since the last periodic location determination or due to changes in the STA MLD 110's trajectory. The selection of which procedure or combination of procedures to use may be based on network policies, STA capabilities, QoS requirements, mobility characteristics, computational resources available, network congestion, proximity of adjacent channel BSSs, roaming urgency, and/or other factors. Each procedure has benefits in different circumstances, with the first procedure 300 providing just-in-time accuracy with minimal ongoing overhead, the second procedure 400 providing continuously updated location tracking for highly mobile STAs or STAs with critical QoS flows, and the third procedure 500 providing integrated location determination during the roaming preparation phase itself (e.g., for scenarios where roaming is less predictable).

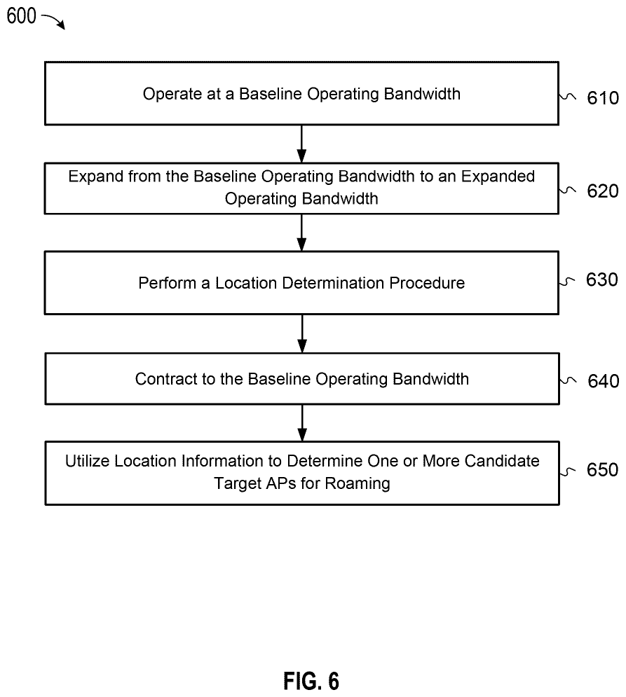

FIG. 6 is a flow diagram illustrating a method 600 for optimizing seamless roaming in a wireless network by coordinating dynamic bandwidth mechanisms with location determination procedures. The method 600 may be performed by an AP, such as the first AP 102, to enable accurate location-based roaming recommendations for a STA, such as the STA MLD 110. The method 600 encompasses the core operations for coordinating bandwidth expansion with location determination that are common to the first procedure 300 (FIG. 3), the second procedure 400 (FIG. 4), and the third procedure 500 (FIG. 5), while allowing flexibility in the specific timing and implementation of these operations.

At stage 610, the AP operates at a baseline operating bandwidth. The baseline operating bandwidth may be a relatively narrow bandwidth, such as 20 MHz or 40 MHz, that the AP and associated STAs use for normal data communication. The baseline operating bandwidth may be selected based on network conditions, spectrum availability, interference from adjacent channel BSSs, density of STAs, and/or other factors. Operating at the baseline operating bandwidth enables efficient spectrum usage and minimizes interference with adjacent channel BSSs during normal operation when high-accuracy location determination is not needed.

At stage 620, the AP expands from the baseline operating bandwidth to an expanded operating bandwidth for a STA associated with the AP. The expanded operating bandwidth is wider than the baseline operating bandwidth and may be, for example, 80 MHz, 160 MHz, or 320 MHz. The expansion from the baseline operating bandwidth to the expanded operating bandwidth enables higher accuracy location determination by providing improved time resolution for ranging measurements. The expanding may be performed using any one of DBS, DBE, DBO, or NPCA. The AP may determine which dynamic bandwidth mechanism to use based on one or more factors, including a period within which roaming is expected to occur, whether expanding the baseline operating bandwidth is for only the STA or a plurality of STAs including the STA, and an expected impact on an adjacent channel BSS. For example, when roaming is expected within approximately 1 second, the AP may use DBS with beacon announcement to provide broader notification of the bandwidth change. When roaming is more imminent, such as within approximately 100 milliseconds, the AP may use DSO or NPCA with group control signaling to enable faster bandwidth expansion with reduced signaling overhead.

In some embodiments, the expanding at stage 620 may be initiated by the STA. For example, the AP may receive, from the STA, a request to expand the baseline operating bandwidth, where the request includes a reason code indicating bandwidth expansion for roaming accuracy with location measurement. The AP may then expand from the baseline operating bandwidth to the expanded operating bandwidth in response to the request. In other embodiments, the expanding at stage 620 may be initiated by the AP itself, such as when the AP determines that the STA's uplink RSSI has degraded beyond a threshold or when the AP determines that accurate location information is needed for roaming optimization.

At stage 630, the AP and the STA perform a location determination procedure at the expanded operating bandwidth to determine location information for the STA. The location determination procedure may comprise an FTM-based location determination or an ultra-wideband location determination. For FTM-based location determination, the AP and STA exchange FTM frames to measure times of flight of messages, enabling determination of the distance between the AP and the STA with high accuracy due to the expanded operating bandwidth. The FTM procedure may include a reason code indicating ‘roaming’ or ‘better roaming accuracy’ as the purpose of the FTM procedure, enabling the AP to optimize FTM configuration by selecting appropriate ranging burst specifications, bandwidth, duration, number of bursts, and burst period. The location determination procedure may involve FTM exchanges between the STA and multiple APs (including the AP performing the method 600) to enable trilateration or multilateration techniques for determining the location of the STA. For ultra-wideband location determination, the AP and STA may perform ultra-wideband ranging procedures that provide high accuracy location measurements without requiring bandwidth expansion in the Wi-Fi spectrum, as ultra-wideband operates in a separate frequency band. The location information determined at stage 630 may include the current location of the STA and may be used to predict the trajectory of the STA based on multiple location measurements over time.

At stage 640, the AP contracts from the expanded operating bandwidth to the baseline operating bandwidth. The contraction returns the AP and STA to the baseline operating bandwidth used for normal data communication, minimizing the time period during which the expanded bandwidth is used and thereby reducing interference with adjacent channel BSSs and preserving spectrum efficiency. The contraction may occur automatically upon completion of the location determination procedure at stage 630, upon expiration of a time period specified for the bandwidth expansion, or in response to a signaling message from the STA or AP indicating that the location determination is complete.

At stage 650, the AP utilizes the location information to determine one or more candidate target APs for roaming of the STA from the AP to at least one of the one or more candidate target APs. The AP may analyze the location information obtained at stage 630 to predict the trajectory of the STA, identifying the direction and velocity of the STA's movement. Based on the predicted trajectory, the AP may identify candidate target APs that are along the STA's predicted path and may rank these candidate target APs in preference order based on factors such as distance to the predicted path, signal strength, capacity, and/or other considerations. The AP may avoid identifying as candidate target APs those APs that the STA is moving away from, even if those APs currently have strong signal strength. By utilizing accurate location information obtained over the expanded operating bandwidth, the AP can provide more accurate candidate target AP recommendations compared to recommendations based solely on RSSI measurements or location information obtained at narrow bandwidth.

Following stage 650, the method 600 may proceed differently depending on the timing procedure used for the bandwidth expansion and location determination. In some embodiments corresponding to the first procedure 300 illustrated in FIG. 3, stages 620, 630, and 640 may be performed prior to the STA sending an ST preparation request to the AP. In such embodiments, the method 600 may further include the AP providing to the STA a recommendation identifying the one or more candidate target APs, and the AP receiving from the STA an ST preparation request based on the recommendation. The recommendation may be provided using a Neighbor Report, a BTM Request, a Link Reconfiguration Notify frame, or other signaling. This procedure enables the STA to have accurate candidate target AP information before initiating the roaming preparation phase.

In other embodiments corresponding to the second procedure 400 illustrated in FIG. 4, the method 600 may further include periodically expanding from the baseline operating bandwidth to the expanded operating bandwidth (stage 620), performing the location determination procedure (stage 630), and contracting from the expanded operating bandwidth to the baseline operating bandwidth (stage 640) to maintain updated location information for the STA. The periodic performance of stages 620, 630, and 640 may occur during service periods established between the AP and the STA, such as via SCS QoS Characteristics, TWT, R-TWT, or similar mechanisms. The service periods may have a sufficiently high frequency to capture mobility of the STA, such as 20 milliseconds for voice applications or 17.5 milliseconds for video applications. The AP may utilize the updated location information to determine one or more updated candidate target APs for roaming of the STA, may provide to the STA a recommendation identifying the one or more updated candidate target APs, and may receive from the STA an ST preparation request based on the recommendation. The second procedure 400 enables the AP to maintain continuously updated location and trajectory information, providing highly accurate roaming recommendations when the STA determines to initiate roaming.

In still other embodiments corresponding to the third procedure 500 illustrated in FIG. 5, expanding from the baseline operating bandwidth to the expanded operating bandwidth (stage 620), performing the location determination procedure (stage 630), and contracting from the expanded operating bandwidth to the baseline operating bandwidth (stage 640) may occur during a roaming preparation phase. In such embodiments, the method 600 may further include the AP receiving from the STA an ST preparation request, performing stages 620, 630, and 640 after receiving the ST preparation request, performing context transfer between the AP and the one or more candidate target APs determined at stage 650, and sending to the STA an ST preparation response identifying the one or more candidate target APs. The third procedure 500 enables location determination to occur at the exact time when roaming preparation occurs, ensuring that the candidate target AP recommendations are based on the most current location and trajectory information available.

The method 600 provides significant advantages for seamless roaming optimization by coordinating dynamic bandwidth mechanisms with location determination procedures. By performing location determination at an expanded operating bandwidth, the method 600 enables high-accuracy location measurements that support accurate trajectory prediction and candidate target AP selection. By contracting back to the baseline operating bandwidth after location determination is complete, the method 600 minimizes interference with adjacent channel BSSs and preserves spectrum efficiency. By utilizing the accurate location information to determine candidate target APs, the method 600 improves roaming success rates, reduces latency during roaming, and enhances quality of service for mobile STAs. The flexibility of the method 600 to be implemented according to different timing procedures (such as the first procedure 300, second procedure 400, or third procedure 500) enables optimization based on network conditions, STA characteristics, and roaming requirements.

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for providing high accuracy roaming with location determination and dynamic bandwidth mechanisms. Computing device 700, for example, may provide an operating environment for the first AP 102, the second AP 104, the third AP 106, the fourth AP 108, the STA MLD 110, the controller 120, and the like. The first AP 102, the second AP 104, the third AP 106, the fourth AP 108, the STA MLD 110, the controller 120, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 700 on the single integrated circuit (chip).

FIG. 8 illustrates an implementation of a communications device 800 that may implement one or more of the first AP 102, the second AP 104, the third AP 106, the fourth AP 108, the STA MLD 110, the controller 120, etc. In various implementations, the communications device 800 may comprise a logic circuit. The logic circuit may include physical circuits to perform operations described for one or more of the first AP 102, the second AP 104, the third AP 106, the fourth AP 108, the STA MLD 110, the controller 120, etc., for example. As shown in FIG. 8, the communications device 800 may include one or more of, but is not limited to, a radio interface 810, baseband circuitry 830, and/or the computing device 700.

The communications device 800 may implement some or all of the structures and/or operations for the first AP 102, the second AP 104, the third AP 106, the fourth AP 108, the STA MLD 110, the controller 120, etc., storage medium, and logic circuit in a single computing entity, such as entirely within a single device. Alternatively, the communications device 800 may distribute portions of the structure and/or operations using a distributed system architecture, such as a client station server architecture, a peer-to-peer architecture, a master-slave architecture, etc.

A radio interface 810, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 810 may include, for example, a receiver 815 and/or a transmitter 820. The radio interface 810 may include bias controls, a crystal oscillator, and/or one or more antennas 825. In additional or alternative configurations, the radio interface 810 may use oscillators and/or one or more filters, as desired.

The baseband circuitry 830 may communicate with the radio interface 810 to process, receive, and/or transmit signals and may include, for example, an Analog-To-Digital Converter (ADC) for down converting received signals with a Digital-To-Analog Converter (DAC) 835 for up converting signals for transmission. Further, the baseband circuitry 830 may include a baseband or PHY layer processing circuit for the PHY link layer processing of respective receive/transmit signals. Baseband circuitry 830 may include, for example, a MAC processing circuit 840 for MAC/data link layer processing. Baseband circuitry 830 may include a memory controller for communicating with MAC processing circuit 840 and/or a computing device 700, for example, via one or more interfaces 845.

In some configurations, PHY processing circuit may include a frame construction and/or detection module, in combination with additional circuitry such as a buffer memory, to construct and/or deconstruct communication frames. Alternatively or in addition, MAC processing circuit 840 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
operating, by an access point (AP), at a baseline operating bandwidth;
expanding, by the AP, from the baseline operating bandwidth to an expanded operating bandwidth for a station (STA) associated with the AP;
performing, by the AP and the STA, a location determination procedure at the expanded operating bandwidth to determine location information for the STA;
contracting, by the AP, from the expanded operating bandwidth to the baseline operating bandwidth; and
utilizing, by the AP, the location information to determine one or more candidate target APs for roaming of the STA from the AP to at least one of the one or more candidate target APs.

2. The method of claim 1, wherein the location determination procedure comprises a fine time measurement-based location determination or an ultra-wideband location determination.

3. The method of claim 1, wherein:
expanding the baseline operating bandwidth to the expanded operating bandwidth for the STA comprises using any one of dynamic bandwidth selection, dynamic bandwidth expansion, dynamic sub-band operation, or non-primary channel access; and
determining, by the AP, to use dynamic bandwidth selection, dynamic bandwidth expansion, dynamic sub-band operation, or non-primary channel access is based on one or more of a period within which roaming is expected to occur, whether expanding the baseline operating bandwidth is for only the STA or a plurality of STAs including the STA, and an expected impact on an adjacent channel basic service set.

4. The method of claim 1, wherein the expanding comprises:
receiving, by the AP from the STA, a request to expand the baseline operating bandwidth, the request including a reason code indicating bandwidth expansion for roaming accuracy with location measurement; and
expanding, by the AP in response to the request, from the baseline operating bandwidth to the expanded operating bandwidth.

5. The method of claim 1, further comprising:
providing, by the AP to the STA, a recommendation identifying the one or more candidate target APs; and
receiving, by the AP from the STA, a seamless transition (ST) preparation request based on the recommendation.

6. The method of claim 1, further comprising:
periodically expanding from the baseline operating bandwidth to the expanded operating bandwidth, performing the location determination procedure, and contracting from the expanded operating bandwidth to the baseline operating bandwidth to maintain updated location information for the STA;
utilizing, by the AP, the updated location information to determine one or more updated candidate target APs for roaming of the STA from the AP to at least one of the one or more updated candidate target APs;
providing, by the AP to the STA, a recommendation identifying the one or more updated candidate target APs; and
receiving, by the AP from the STA, a seamless transition (ST) preparation request based on the recommendation.

7. The method of claim 1, wherein:
expanding from the baseline operating bandwidth to the expanded operating bandwidth, performing the location determination procedure at the expanded operating bandwidth to determine the location information for the STA, and contracting from the expanded operating bandwidth to the baseline operating bandwidth occur during a roaming preparation phase;
the method further comprises:
receiving, by the AP from the STA, a seamless transition (ST) preparation request;
performing context transfer between the AP and the one or more candidate target APs; and
sending, by the AP to the STA, an ST preparation response identifying the one or more candidate target APs.

8. A system comprising:
a memory storage; and
a processing unit coupled to the memory storage, wherein the processing unit is operative to:
operate at a baseline operating bandwidth;
expand from the baseline operating bandwidth to an expanded operating bandwidth for a station (STA) associated with the system;
perform, with the STA, a location determination procedure at the expanded operating bandwidth to determine location information for the STA;
contract from the expanded operating bandwidth to the baseline operating bandwidth; and
utilize the location information to determine one or more candidate target access points (APs) for roaming of the STA from the system to at least one of the one or more candidate target APs.

9. The system of claim 8, wherein the location determination procedure comprises a fine time measurement-based location determination or an ultra-wideband location determination.

10. The system of claim 8, wherein:
to expand the baseline operating bandwidth to the expanded operating bandwidth for the STA comprises to use any one of dynamic bandwidth selection, dynamic bandwidth expansion, dynamic sub-band operation, or non-primary channel access; and
the processing unit is operative to determine to use dynamic bandwidth selection, dynamic bandwidth expansion, dynamic sub-band operation, or non-primary channel access based on one or more of a period within which roaming is expected to occur, whether expanding the baseline operating bandwidth is for only the STA or a plurality of STAs including the STA, and an expected impact on an adjacent channel basic service set.

11. The system of claim 8, to expand from the baseline operating bandwidth to the expanded operating bandwidth comprises to:
receive, from the STA, a request to expand the baseline operating bandwidth, the request including a reason code indicating bandwidth expansion for roaming accuracy with location measurement; and
expand, in response to the request, from the baseline operating bandwidth to the expanded operating bandwidth.

12. The system of claim 8, wherein the processing unit is further operative to:
provide, to the STA, a recommendation identifying the one or more candidate target APs; and
receive, from the STA, a seamless transition (ST) preparation request based on the recommendation.

13. The system of claim 8, wherein the processing unit is further operative to:
periodically expand from the baseline operating bandwidth to the expanded operating bandwidth, perform the location determination procedure, and contract from the expanded operating bandwidth to the baseline operating bandwidth to maintain updated location information for the STA;
utilize the updated location information to determine one or more updated candidate target APs for roaming of the STA from the system to at least one of the one or more updated candidate target APs;
provide, to the STA, a recommendation identifying the one or more updated candidate target APs; and
receive, from the STA, a seamless transition (ST) preparation request based on the recommendation.

14. The system of claim 8, wherein:
the processing unit is operative to expand from the baseline operating bandwidth to the expanded operating bandwidth, perform the location determination procedure at the expanded operating bandwidth to determine the location information for the STA, and contract from the expanded operating bandwidth to the baseline operating bandwidth during a roaming preparation phase;
the processing unit is further operative to:
receive, from the STA, a seamless transition (ST) preparation request;
perform context transfer with the one or more candidate target APs; and
send, to the STA, an ST preparation response identifying the one or more candidate target APs.

15. A non-transitory computer-readable medium that stores a set of instructions which when executed perform a method comprising:
operating at a baseline operating bandwidth;
expanding from the baseline operating bandwidth to an expanded operating bandwidth for a station (STA);
performing, with the STA, a location determination procedure at the expanded operating bandwidth to determine location information for the STA;
contracting from the expanded operating bandwidth to the baseline operating bandwidth; and
utilizing the location information to determine one or more candidate target access points (APs) for roaming of the STA to at least one of the one or more candidate target APs.

16. The non-transitory computer-readable medium of claim 15, wherein the location determination procedure comprises a fine time measurement-based location determination or an ultra-wideband location determination.

17. The non-transitory computer-readable medium of claim 15, wherein:
expanding the baseline operating bandwidth to the expanded operating bandwidth for the STA comprises using any one of dynamic bandwidth selection, dynamic bandwidth expansion, dynamic sub-band operation, or non-primary channel access; and
determining to use dynamic bandwidth selection, dynamic bandwidth expansion, dynamic sub-band operation, or non-primary channel access is based on one or more of a period within which roaming is expected to occur, whether expanding the baseline operating bandwidth is for only the STA or a plurality of STAs including the STA, and an expected impact on an adjacent channel basic service set.

18. The non-transitory computer-readable medium of claim 15, the method executed by the set of instructions further comprising:
providing, to the STA, a recommendation identifying the one or more candidate target APs; and
receiving, from the STA, a seamless transition (ST) preparation request based on the recommendation.

19. The non-transitory computer-readable medium of claim 15, the method executed by the set of instructions further comprising:
periodically expanding from the baseline operating bandwidth to the expanded operating bandwidth, performing the location determination procedure, and contracting from the expanded operating bandwidth to the baseline operating bandwidth to maintain updated location information for the STA;
utilizing the updated location information to determine one or more updated candidate target APs for roaming of the STA to at least one of the one or more updated candidate target APs;
providing, to the STA, a recommendation identifying the one or more updated candidate target APs; and
receiving, from the STA, a seamless transition (ST) preparation request based on the recommendation.

20. The non-transitory computer-readable medium of claim 15, wherein:
expanding from the baseline operating bandwidth to the expanded operating bandwidth, performing the location determination procedure at the expanded operating bandwidth to determine the location information for the STA, and contracting from the expanded operating bandwidth to the baseline operating bandwidth occur during a roaming preparation phase;
the method executed by the set of instructions further comprises:
receiving, from the STA, a seamless transition (ST) preparation request;
performing context transfer with the one or more candidate target APs; and
sending, to the STA, an ST preparation response identifying the one or more candidate target APs.
